(19) United States
(12) Patent Application Publication
(10) Pub. No.: US 2014/0165521 A1
(43) Pub. Date: Jun. 19, 2014

(54) VEGETATION CUTTER

(71) Applicant: MAKITA CORPORATION, Aichi (JP)

(72) Inventor: Yoshifumi MORITA, Aichi (JP)

(21) Appl. No.: 14/132,126

(22) Filed: Dec. 18, 2013

(30) Foreign Application Priority Data
Dec. 19, 2012 (JP) 2012-277066

(51) Int. Cl. A01D 34/10

(52) U.S. Cl. CPC A01D 34/10
USPC 56/10.1

(57) ABSTRACT

A vegetation cutter is comprised of a frame rod assuming a shape of a pole, and having a front end portion and a rear end portion; a cutter head mounted on the front end portion of the frame rod and including a rotary cutter and a drive motor connected to the rotary cutter; a controller head including a control circuit for controlling the drive motor; and a handle fixed to the frame rod to be held by hands of a user. The cutter head includes a cutter frame for enclosing the drive motor therein, rotatably supporting the rotary cutter below the cutter frame and being connected to the front end portion of the frame rod at an upper rear end portion of the cutter frame. The cutter frame is comprised of a shell wall member and a motor enclosure for enclosing the motor.

### TECHNICAL FIELD

The present invention relates to a vegetation cutter such as a grass cutter, a lawn trimmer and a brush cutter, and more particularly to a vegetation cutter which comprises a frame rod, a cutter head mounted on the front end of the frame rod and including a rotary cutter and a drive motor connected to the rotary cutter, controller head mounted on the rear end of the frame rod and including a control circuit for controlling the drive motor, and a handle fixed to the frame rod to be held by hands of the user, in which the shell wall member of the cutter head is provided with a drainage hole for water which might come in to escape out.

### BACKGROUND INFORMATION

A vegetation cutter is a kind of work apparatus for cutting grasses growing on a bank or in a park or in a lawn, and generally comprises a frame rod in the shape of a pole, a cutter head mounted on the front end of the frame rod and including a rotary cutter and a drive motor for rotating the rotary cutter, a controller head mounted on the rear end of the frame rod, and a handle fixed to the frame rod at a middle point thereon nearer to the rear end. When a user operates the vegetation cutter, the user holds the handle with his/her hands keeping the frame rod under his/her arm, and swings the cutter head right and left sweeping forward or backward on the grasses (along the ground) while the rotary cutter is rotating. When this type of vegetation cutter is in use, the frame rod is held aslant with its front end directing downward and forward and its rear end directing upward and backward. Further, when in use outdoors, the apparatus is apt to get wet with rain or dew so that water may travel through the inner bore of the frame rod or along the outer surface of the frame rod to flow into the cutter frame, or may soak inside through some gaps in the outer shell, whereby the water may very probably pool within the cutter frame housing of the cutter head. Particularly in the case of an electric vegetation cutter with an electric motor housed in the cutter head, the water pooled within the cutter head may damage the electric components of the motor. Conventional vegetation cutters, however, have not been so contrived that water is prevented from pooling inside.

### SUMMARY OF THE INVENTION

In view of the foregoing circumstances, therefore, it is a primary object of the present invention to provide a vegetation cutter, in which even if water should enter into the cutter head enclosing the motor by traveling along the frame rod or soaking inside through some gaps in the outer shell, the water would neither pool within the cutter head nor move to the motor area.

According to the present invention, the object is accomplished by providing a vegetation cutter comprising: a frame rod assuming a shape of a pole, and having a front end portion and a rear end portion; a cutter head mounted on the front end portion of the frame rod and including a rotary cutter and a drive motor connected to the rotary cutter; a controller head including a control circuit for controlling the drive motor; and a handle fixed to the frame rod to be held by hands of a user, wherein the cutter head includes a cutter frame for enclosing the drive motor therein, rotatably supporting the rotary cutter below the cutter frame and being connected to the front end portion of the frame rod at an upper rear end portion of the cutter frame, wherein the cutter frame is comprised of a shell wall member and a motor enclosure for enclosing the motor, and wherein a lower tip of the front end portion of the frame rod is located lower than an upper end of the motor enclosure, and the shell wall member has a lower wall portion provided with a drainage hole opening downward therethrough at a position frontward of the lower tip of the front end portion of the frame rod and rearward of the motor enclosure.

In an aspect of the present invention, the lower wall portion of the shell wall member may preferably be formed integrally with a water barrier rising inward from the shell wall member adjacent to the drainage hole at a further side from the lower tip of the front end portion of the frame rod.

In a further aspect of the present invention, the lower wall portion of the shell wall member may preferably be provided with two drainage holes, one being located at a first position confronting the lower tip of the front end portion of the frame rod, and the other being located at a second position just rearward of the motor enclosure.

In a still further aspect of the present invention, the lower wall portion of the shell wall member may preferably be provided with two drainage holes, the first one being located at a first position confronting the lower tip of the front end portion of the frame rod, and the second one being located at a second position just rearward of the motor enclosure, and additionally the lower wall portion of the shell wall member may preferably be formed integrally with a water barrier rising inward from the shell wall member adjacent to the first drainage hole at a further side from the lower tip of the front end portion of the frame rod.

In a still further aspect of the present invention, the drainage hole may preferably be formed in an elongate hole.

In a still further aspect of the present invention, the cutter frame may preferably be made of fiber reinforced plastic.

With the vegetation cutter configured as above, in which the cutter frame of the cutter head is comprised of a shell wall member and a motor enclosure for enclosing the motor, and the lower tip of the front end portion of the frame rod is located lower than the upper end of the motor enclosure, and the shell wall member has a lower wall portion provided with a drainage hole opening downward therethrough at a position frontward of the lower tip of the front end portion of the frame rod and rearward of the motor enclosure, the water which might enter into the cutter head would not pool within the cutter head but escape out through the drainage hole to prevent damage to the motor and the associated components of the vegetation cutter.

### BRIEF DESCRIPTION OF THE DRAWINGS

For a better understanding of the present invention, and to show how the same may be practiced and will work, reference will now be made, by way of example, to the accompanying drawings, in which:

FIG. 1 is an overall perspective view of an embodiment of a vegetation cutter according to the present invention;

FIG. 2 is a side elevational view of a right-half assembly of an embodiment of a cutter head as viewed from the inside of the otherwise whole assembly, where the cutter frame is manufactured by double-split molding; and

FIG. 3 is a bottom view of an embodiment of a cutter frame, where a rotary cutter is not assembled.

### DETAILED DESCRIPTION OF EMBODIMENTS OF THE INVENTION

The invention and its embodiment can now be better understood by turning to the following detailed description of the preferred embodiment with reference to the accompanying drawings. The embodiment of the vegetation cutter hereunder described is of an electric motor-driven type.

It should be expressly understood that the illustrated embodiment is presented just as a practicable example of the invention and that the invention as defined by the claims may be broader than the illustrated embodiment described below. In the drawing, like reference characters refer to like parts so that repetitive explanations may be omitted.

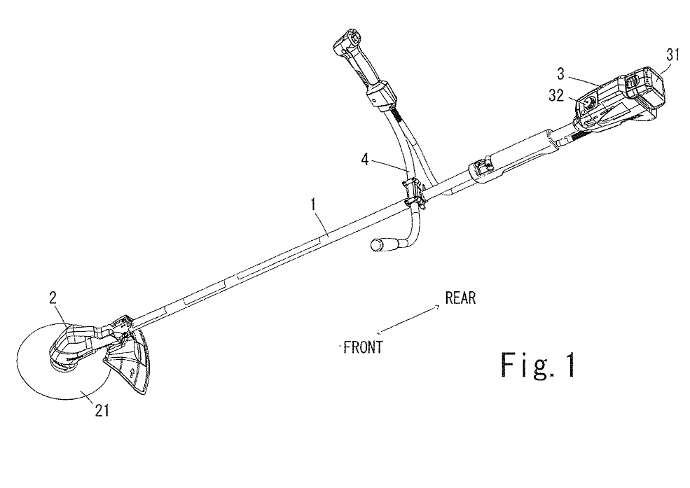

FIG. 1 illustrates an overall view of an embodiment of a vegetation cutter according to the present invention, in which on the front end part of a frame rod 1 is mounted a cutter head 2, on the rear end part of the frame rod 1 is mounted a controller head 3, and to the frame rod 1 at a middle part thereon nearer to the rear end is fixed a handle 4. The user of the vegetation cutter holds the handle 4 with his/her hands keeping the frame rod 1 under his/her arm, and swings the cutter head 2 right and left sweeping forward or backward on the grasses along the ground surface, thereby cutting the grasses by the rotating rotary cutter 21.

In the illustrated embodiment of the vegetation cutter according to the present invention, the cutter head 2 comprises a cutter frame for enclosing a drive motor and a reduction gear and for rotatably holding the rotary cutter 21 exposed outside below the cutter frame, and the controller head 3 carries a replaceable battery 31 and is provided with a control knob 32 for controlling a control circuit contained in the controller head 3 so as to controllably supply the electric power of the battery 31 to the drive motor in the cutter head 2, thereby operating the vegetation cutter under control.

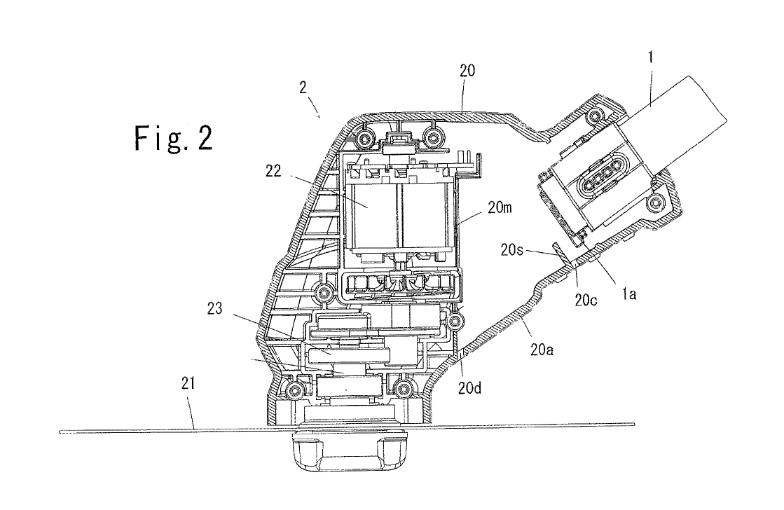

Turning now to FIG. 2 which illustrates a right-half assembly of the cutter head 2 as viewed from the inside of the otherwise whole assembly, the cutter frame 20 of the cutter head 2 is manufactured from fiberglass reinforced polycarbonate resin containing 30% of fiberglass (PC-GF30) by double-split molding in the shape of an enclosure shell. The cutter frame 20 is mainly made of a platelike wall member, and encloses, in a motor enclosure area, the drive motor 22 and the reduction gear 23, and rotatably holds the rotary cutter 21 outside and below the cutter frame 20. The upper rear end portion (upper right-hand part in FIG. 2) of the cutter frame 20 is coupled to the front end portion of the frame rod 1. As the frame rod 1 is a hollow tube, once water sneaks into the frame rod 1, the water will travel down along the inner wall of the tube and drops off from the lower tip 1 a of the frame rod 1 (i.e. the bottom end of the water path) into the inner space of the cutter frame 20. The bottom end 1 a of the water path is located lower than the upper edge of the motor enclosure 20m which encloses the drive motor 22 and the reduction gear 23, so that the fallen water will not go into the motor enclosure 20m to wet the drive motor 22 and the reduction gear 23. Where water gets on to the outer wall of the frame rod 1, the water travels down along the lower surface of the outer wall toward the cutter frame 20 to finally get into the inside space of the cutter frame 20 through a gap etc. of the cutter frame 20.

The lower wall portion 20a of the shell wall member of the cutter frame 20 is provided with drainage holes 20c and 20d for water escape opening downward therethrough at the positions frontward (i.e. leftward in FIG. 2) of the lower tip la of the front end portion of the frame rod 1 and rearward (i.e. rightward in FIG. 2) of the motor enclosure 20m. The drainage hole 20c is formed in the lower shell wall 20a at the position confronting the lower tip 1 a of the frame rod 1. The lower shell wall 20a is formed with a water barrier plate 20s rising integrally therefrom at the position adjacent the drainage hole 20c and in the further side from the lower tip la of the frame rod 1. With this arrangement, when water comes in after traveling along the frame rod 1, the water is barred by the water barrier plate 20s and flows out downward through the drainage hole 20c. The drainage hole 20d is formed at the position just rearward of the motor enclosure 20m so that the water which gets in further frontward (downward) of the water barrier plate 20s will flow out downward through the drainage hole 20d.

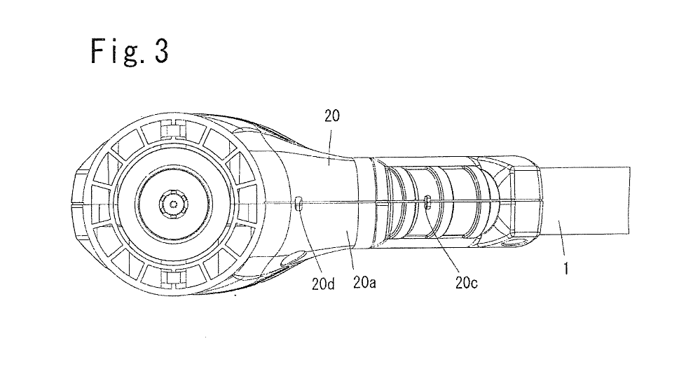

FIG. 3 is the bottom view of the cutter head 2 with the rotary cutter 21 disassembled. As shown in FIG. 3, the drainage holes 20c and 20d are formed in the shape of an elongate hole. While a small circular hole would likely to establish a spherical water film formed across the hole due to the surface tension of water and would prevent the water from going out through the hole, the elongate shape will hinder the water from establishing a film connection across the hole due to the surface tension of water, and will allow the water to flow out through the hole.

While, in the illustrated embodiment, the controller head 3 containing the controlling circuit is mounted on the rear end part of the frame rod 1, the part of the controller head 3 that contains the control circuit may be incorporated within the cutter frame 20 of the cutter head 2, or the control circuit may be incorporated within the drive motor 22. The control knob 32 may be disposed at a suitable position on the handle 4 in place of mounting the controller head 3 on the rear end portion of the frame rod 1 with the control knob 32 provided on the controller head 3.

With the vegetation cutter according to the present invention, as described above, even if water gets into the cutter head enclosing the drive motor of the vegetation cutter after traveling along the frame rod or soaking through a gap in the shell wall member of the cutter frame, the water will neither stay within the cutter frame of the cutter head nor go to the area enclosing the drive motor. Thus, the possibility of the trouble with the vegetation cutter will diminish accordingly.

1. A vegetation cutter comprising:
a frame rod assuming a shape of a pole, and having a front end portion and a rear end portion;
a cutter head mounted on the front end portion of the frame rod and including a rotary cutter and a drive motor connected to the rotary cutter;
a controller head including a control circuit for controlling the drive motor; and
a handle fixed to the frame rod to be held by hands of a user,
wherein the cutter head includes a cutter frame for enclosing the drive motor therein, rotatably supporting the rotary cutter below the cutter frame and being connected to the front end portion of the frame rod at an upper rear end portion of the cutter frame,
wherein the cutter frame is comprised of a shell wall member and a motor enclosure for enclosing the motor, and
wherein a lower tip of the front end portion of the frame rod is located lower than an upper edge of the motor enclosure, and the shell wall member has a lower wall portion provided with a drainage hole opening downward therethrough at a position frontward of the lower tip of the front end portion of the frame rod and rearward of the motor enclosure.

2. A vegetation cutter as claimed in claim 1, wherein the lower wall portion of the shell wall member is formed integrally with a water barrier plate rising inward from the shell wall member adjacent to the drainage hole at a further side from the lower tip of the front end portion of the frame rod.

3. A vegetation cutter as claimed in claim 1, wherein the lower wall portion of the shell wall member is provided with two drainage holes, one being located at a first position confronting the lower tip of the front end portion of the frame rod, and the other being located at a second position just rearward of the motor enclosure.

4. A vegetation cutter as claimed in claim 1, wherein the drainage hole is formed in the shape of an elongate hole.

5. A vegetation cutter as claimed in claim 1, wherein the cutter frame is made of fiber reinforced plastic.
